(19) United States
(12) Patent Application Publication
(10) Pub. No.: US 2026/0042368 A1
(43) Pub. Date: Feb. 12, 2026

(54) ELECTRIC VEHICLE PARKING STOP CHARGING STATION

(71) Applicant: Domenic Anthony Screnci, Jr., Boston, MA (US)

(72) Inventor: Domenic Anthony Screnci, Jr., Boston, MA (US)

(21) Appl. No.: 18/797,714

(22) Filed: Aug. 8, 2024

(51) Int. Cl. B60L 53/31; B60L 53/16; B60L 53/18

(52) U.S. Cl. CPC B60L 53/31; B60L 53/16; B60L 53/18

(57) ABSTRACT

An EV charging station that is incorporated within a parking stop for charging an electric vehicle. The assembly comprises a housing and a hinged door that house a movable charging block and EV plug that are connected via a cable to charge an EV.

### BACKGROUND OF THE INVENTION

As the number of electric vehicles (EV) on the road grows, there is a critical need for infrastructure to support them. Charging stations provide a necessary service for EV owners, ensuring they can charge their vehicles conveniently and reliably. One of the main concerns for potential EV buyers is range anxiety—the fear of running out of battery charge before reaching a destination. Having a network of charging stations helps alleviate this anxiety by providing reassurance that drivers can recharge as needed.

The need for charging stations is particularly pronounced for people living in condominiums or townhomes due to several challenges unique to these residential settings. For example, condominiums and townhomes often have limited or assigned parking spaces, which can make it difficult for residents to install personal EV chargers. Many condominiums and townhomes also have strict building regulations or homeowner association (HOA) rules that govern modifications to the property, including installation of electrical infrastructure like EV chargers. In addition, not all condominiums or townhomes are equipped with sufficient electrical infrastructure to support EV charging.

Having EV charging stations onsite enhances convenience for residents, allowing them to charge their vehicles conveniently at home. This is particularly important for daily charging needs, as well as for residents who may not have easy access to public charging stations nearby.

Many existing parking lots, including those located in public housing areas, already employ the use of parking stops. A parking stop, also known as a parking curb, wheel stop, or bumper block, is a physical barrier placed at the end of a parking space or along the edge of a parking lot. Its primary purpose is to prevent vehicles from rolling too far forward or backward beyond a designated parking space.

The present invention relates to electric vehicle charging stations and, more particularly, to an electric vehicle charging station that is incorporated within a parking stop barrier.

### SUMMARY OF THE INVENTION

In one aspect of the present invention, there is disclosed electric vehicle charging components that are housed within a parking stop.

In another aspect of the present invention, the electric vehicle parking stop charging station of the present invention comprises a housing that is shaped like a conventional parking stop and is secured to the parking surface and includes a door that can locked and pivoted to an open position. Within the housing are the components necessary for charging an electric vehicle, including a charging block that can be moved to an upright and locked position, with a charging plug connected to the block via a cable. Power is supplied to the components such that when open and deployed, an electric vehicle can be charged.

These and other features, aspects and advantages of the present invention will become better understood with reference to the following drawings, description and claims.

### BRIEF DESCRIPTION OF THE DRAWINGS

FIG. 1 is a perspective view of an electric vehicle parking stop charging station in accordance with a preferred embodiment of the present invention;

FIG. 2 is a section view taken along line 2-2 in FIG. 1;

FIG. 3 is a section view showing the motion of the charging block when in an open position and the charger is positioned for charging a vehicle;

FIG. 4 is a section view showing the motion of the charging block when in an open position and the charger is positioned in a stored postion; and

FIG. 5 is a section view showing the motion of the charging block when in a closed position;

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides an EV charging station that is incorporated within a parking stop. As discussed above, access to electric vehicle charging stations in small parking lots where traditional EV charging solutions is often not practical. The invention claimed here solves this and other problems.

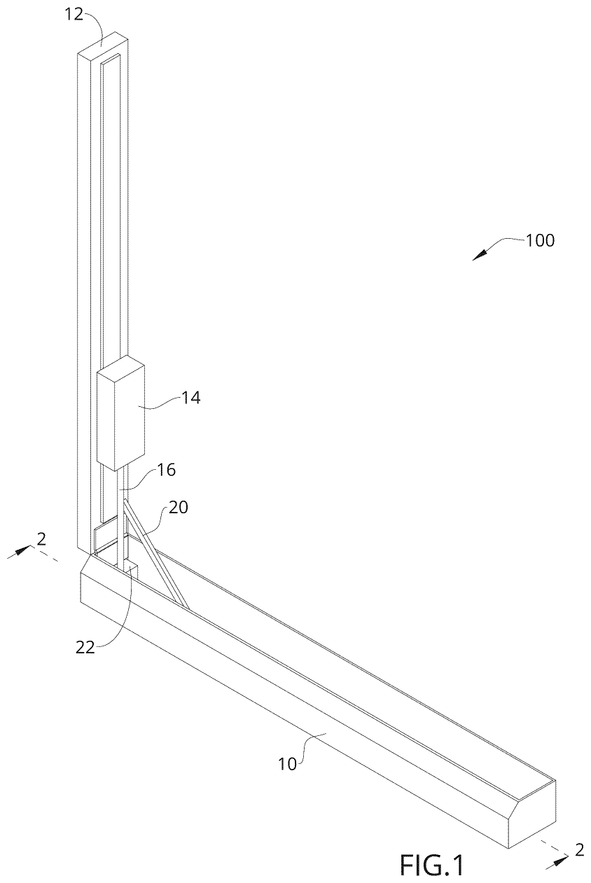

The charging station of the present invention is incorporated into a physical element that is commonly used in parking lots (e.g., the parking stop). As seen in FIGS. 1-5, the EV charging station assembly 100 is essentially in the shape of a conventional parking stop that is commonly used in parking lots today. The assembly 100 comprises a housing 10 that is secured to the parking lot surface via one or more bolts 24. A door 12 with a handle 26 is secured to housing 10 via a pneumatic hinge 20.

The primary EV charging components that are housed within assembly 100 comprise a (third part) charging block 14 that is connected to a charging plug via a charging cable 16. An AC cable conduit 22 is also positioned within housing 10 to provide power to the assembly.

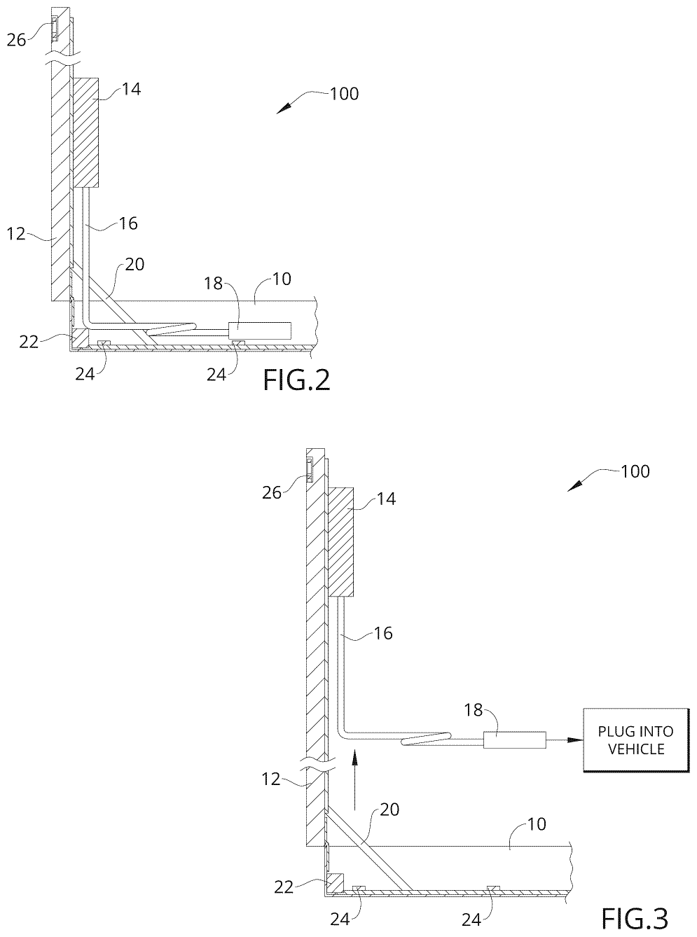

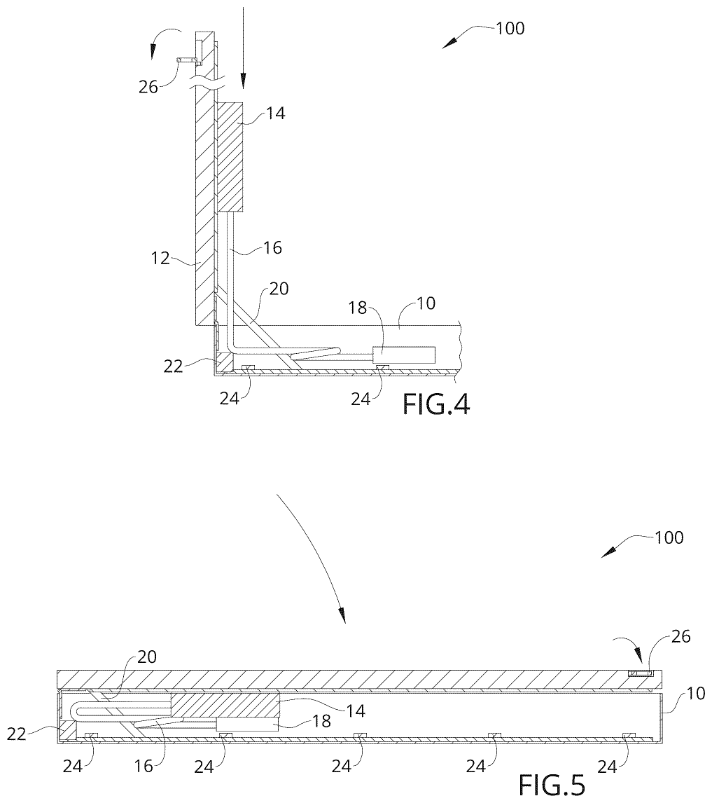

A user can access the third party EV charging components that are stored within assembly 100 by gripping the handle 26 (which will include a locking mechanism) to pivot door 12 into an open position (as seen in FIGS. 1 and 2, by way of example). The charging block 14 can then be raised to a locked position along a rail system or otherwise to get access to the charging plug as seen in FIG. 3 in order to charge the EV. Once charging is completed, the charging block 14, plug 18 and associated cable 16 can be lowered into the housing (see FIG. 4, and the door 12 can be closed to securely store the charging equipment within housing 10 (see FIG. 5).

In a preferred embodiment, the housing will be made of cast iron or some other similar and/or suitable material, and door 12 will be made of lighter material than the cast or steel shell to enable easier opening.

In a preferred embodiment, each of the primary structural components will be coated in a rubberized material, and all penetrating holes will have a water and rubber seal/gaskets to prevent water from entering the structure.

In a preferred embodiment, there will be six bolt-type fasteners (24) to keep the structure in place, and all penetrating holes for bolts will be water-gapped with welded metal collars and rubber-gasket bolts.

In a preferred embodiment, there will be an access hole to connect to an electrical underground conduit so power can be supplied to the charging station. This will be a gasketed watertight structure.

In a preferred embodiment, the system will be constructed for both left and right-side installation, and the lid could be right or left-handed. Since some cars have their EV connection on the front or the back of their car, the present invention will allow cars to be driven into or backed into the parking spot for easy access and maximum flexibility.

In a preferred embodiment, there will also be a locking system to secure the opening without permission.

In a preferred embodiment, there will be an electrical switch included to shut off power to the EV charging station when not used or for maintenance.

The charging station of the present invention is easy to use. The owner of an electric vehicle parks their car, ensuring there is enough clearance from the device to operate as intended. If the device's power has been turned off, it must be turned on. They will then move to the device, unlock it, and lift the lid 12. Once the lid 12 is upright and locked, the operator will unlock the EV charging block 14 so it can be slid up and locked in place. This will give the height and space to allow the operator to work. They will pull out the appropriate charging cable 16 and plug 18 needed for their make and model of EV that has been stored in the device 100 for easy access. Plug it into the charging station and then into their vehicle to start the charging process. Once the EV is fully charged, the user will turn off the charging station, disconnect the cables, and store them back in the device. They will unlock and lower the EV charging station into its stored position. They will close and lock the lid with the weight of the lid being managed via a pneumatic hinge to prevent the lid from falling down during opening and closing to avoid damage to the system or operator.

If it snows, the parking stop EV charging station will be more impervious to damage because of its low profile and structure construction from plows needing to clear a lot of snow. If the device is covered with snow, it can be dug out and used as intended.

The interior of door 12 will have a rail system installed with a mounting plate for the EV charging block and locking systems in place for the stored/lower position and one for its use/top position. In a preferred embodiment, the EV charging block will be a conventional charging block available from one or more third parties.

This invention offers an alternative to the traditional Electric Vehicle (EV) charging stations available on the market. This EV charging station is especially useful in compact parking lots. However, it could be installed in any parking lot that uses car parking stops to manage individual parking stations/locations. The proposed system offers an alternative to existing exterior EV charging technologies. It offers a secure and protected system for parking lots with deeded or designated parking spaces. Or any parking lot that wants to make the opportunity for charging EVs ubiquitous within outdoor or indoor parking properties. The proposed invention also offers protection from plows moving snow around in tight parking areas where traditional EV-standing charging systems could be damaged.

It should be understood, of course, that the foregoing relates to exemplary embodiments of the invention and that modifications may be made without departing from the spirit and scope of the invention as set forth in the following claims.

What is claimed is:

1. An electric vehicle parking stop charging station comprising:
a housing adapted to be secured to a parking lot surface;
a door pivotally connected to the housing and movable between a closed position sealing the interior of the housing and an open position approximately 90 degrees from the open position;
an electrical vehicle charging block slidingly connected to an interior surface of the door;
the charging block electrically connected to an electrical power source, and having a charging cable connected thereto, the charging cable having a charging plug at one end thereof;
the charging block being movable between a closed position when the door is closed and an open position when the door is open;
wherein the charging plug can be connected to an electrical vehicle when the charging block is in its open position.

2. The charging station of claim 1, wherein the housing is substantially in the shape of a parking stop.

3. The charging station of claim 1, wherein the charging block, the charging cable, and the charging plug all fit within the housing when the door is in its closed position.

4. The charging station of claim 1, wherein the door further comprises a lockable handle.

5. The charging station of claim 1, wherein the housing further comprises a conduit for housing an AC cable for providing electrical power to the charging block.

6. The charging station of claim 1, wherein the door provides a watertight seal to the interior of the housing when in its closed position.

7. The charging station of claim 1, wherein the door is connected to the housing via a pneumatic hinge.

8. The charging station of claim 1, wherein the charging plug is shaped to engage a conventional electric vehicle.
